(19) United States
(12) Patent Application Publication
(10) Pub. No.: US 2025/0289291 A1
(43) Pub. Date: Sep. 18, 2025

(54) SYSTEM AND METHOD FOR POWER SUPPLY MANAGEMENT IN A TRANSPORT REFRIGERATION UNIT

(71) Applicant: Carrier Corporation, Palm Beach Gardens, FL (US)

(72) Inventors: Florian Beaufrere, Rouen (FR); Lionel Pourcheresse, Le Mesnil Esnard (FR); Jean Michel Vadecard, Montmain (FR); Gael Ducher, Olivet (FR); Bruno Chakiachvili, Saint Aubin Epinay (FR); Guillaume Charoulet, Rouen (FR)

(21) Appl. No.: 19/077,278

(22) Filed: Mar. 12, 2025

Related U.S. Application Data
(60) Provisional application No. 63/565,632, filed on Mar. 15, 2024.

(51) Int. Cl. B60H 1/32; B60R 16/033; H01M 10/42; H01M 10/46; H02J 7/16

(52) U.S. Cl. CPC B60H 1/3211; B60H 1/3226; B60R 16/033; H01M 10/425; H01M 10/46; H02J 7/16; H01M 2010/4271

(57) ABSTRACT

Disclosed herein is a power supply system for a transport refrigeration unit (TRU). The system comprises a battery, and a generator connected to the battery. The generator is operatively coupled to an axle of a trailer to generate electrical power upon rotation of the axle. The system further comprises a controller configured to activate the generator to generate and supply the electrical power to the battery and/or the TRU during the a trip after the TRU depletes energy stored in the battery to or below a threshold state of charge (SoC) level.

### CROSS-REFERENCE TO RELATED APPLICATION

This patent application claims the benefit of U.S. Provisional Patent Application No. 63/565,632, filed on Mar. 15, 2024, which is incorporated by reference herein in its entirety.

### BACKGROUND

The subject disclosure relates to transport refrigeration units and power supply management systems, and more particularly, to a system, method, and control device for power supply management in a transport refrigeration unit (TRU) equipped with a battery and an axle generator.

### SUMMARY

Disclosed herein is a power supply system for a transport refrigeration unit (TRU), where the power supply system includes a battery electrically connected to one or more components of the TRU, a generator electrically connected to the battery, where the generator is operatively coupled to an axle of a trailer of the TRU, the generator being configured to generate electrical power upon rotation of the axle according to a rotational speed of the axle, and a controller operatively coupled to the battery, the TRU, and the generator, where the controller is configured to, activate the generator to generate and supply the electrical power to the battery and/or the TRU during a trip after the TRU depletes energy stored in the battery to or below a threshold state of charge (SoC) level.

In one or more embodiments, the controller may be further configured to, monitor a real-time SoC of the battery, the real-time SoC indicating an amount of energy stored in the battery, predict electrical power consumption of the TRU for the trip, based on data pertaining to an average electrical power consumption of the TRU being monitored over a preceding time interval and in real-time, monitor the rotational speed of the axle during the trip and determine the electrical power generated by the generator based on the rotational speed, and activate the generator to generate and/or supply the electrical power to the battery and/or TRU based on one or more of, the predicted electrical power consumption of the TRU, the real-time SoC of the battery, the threshold SoC level, and the electrical power generated by the generator.

In one or more embodiments, the controller may be further configured to adjust an activation duration of the generator during the trip based on a real-time SoC of the battery and the threshold SoC level.

In one or more embodiments, the threshold SoC level may be selected based on a predicted electrical power consumption of the TRU during the trip and a power storage capacity of the battery.

In one or more embodiments, when a real-time SoC of the battery is more than the threshold SoC level, the controller may be configured to deactivate the generator and enable the battery to supply the energy stored therein to the one or more components of the TRU based on a real-time electrical power consumption of the TRU.

In one or more embodiments, when a real-time SoC of the battery is equal to or less than the threshold SoC level, the controller may be configured to activate the generator to generate and supply the electrical power to the battery and the one or more components of the TRU concurrently, based on a real-time electrical power consumption of the TRU.

In one or more embodiments, when the real-time SoC of the battery is equal to or less than the threshold SoC level, the controller may be configured to activate the generator to generate and supply the electrical power to the TRU based on a real-time electrical power consumption of the TRU, through an electrical connection between the generator and the one or more components.

In one or more embodiments, the controller may be configured to determine the electrical power generated by the generator based on a power-vs-speed characteristic of the generator, and where the power-vs-speed characteristic is determined based on any one or more of, the rotational speed of the axle, one or more design parameters of the trailer and the generator, and one or more road attributes of a road on which the trailer is moving during the trip.

In one or more embodiments, the controller may be further configured to determine and monitor the real-time SoC of the battery using a Battery Management System (BMS) associated with the battery.

In one or more embodiments, the power supply system may further include a power conversion unit to convert the electrical power generated by the generator into direct current (DC) power for the battery and/or into alternating current (AC) or DC power for the one or more components of the TRU.

An aspect of the present disclosure relates to a method for power supply management in a TRU equipped with a generator and a battery, where the method includes, activating the generator to generate and supply electrical power to the battery and/or the TRU during a trip after the TRU depletes energy stored in the battery to or below a threshold SoC level.

In one or more embodiments, the method may further include, monitoring a real-time SoC of the battery, the real-time SoC indicating an amount of energy available in the battery, predicting electrical power consumption of the TRU for the trip, based on data pertaining to an average electrical power consumption of the TRU being monitored over a preceding time interval and in real-time, monitoring a rotational speed of an axle or speed of a trailer associated with the TRU during the trip and correspondingly determining electrical power generated by or available at a generator based on the rotational speed, and activating the generator for generating and supplying the electrical power to the battery and/or the TRU during the trip based on one or more of, the predicted electrical power consumptions of the TRU, the real-time SoC of the battery, the threshold SoC level, and the electrical power available at the generator.

In one or more embodiments, the method may further include the step of adjusting an activation duration of the generator during the trip based on a real-time SoC of the battery above the threshold SoC level during the trip.

In one or more embodiments, the threshold SoC level may be selected based on the predicted electrical power consumption of the TRU during the trip and a power storage capacity of the battery.

In one or more embodiments, the method may further include deactivating the generator and enabling the battery to supply the energy stored therein to one or more components of the TRU based on a real-time electrical power consumption of the TRU, when the real-time SoC of the battery is more than the threshold SoC level.

In one or more embodiments, when a real-time SoC of the battery is equal to or less than the threshold SoC level, the method includes activating the generator to generate and supply the electrical power to the battery until the real-time SoC of the battery reaches another threshold SoC level, where the another threshold SoC level is more than the threshold SoC level.

In one or more embodiments, the method may further include activating the generator for generating and supplying the electrical power to the battery and one or more components of the TRU based on a real-time electrical power consumption of the TRU, when a real-time SoC of the battery is equal to or below the threshold SoC level.

In one or more embodiments, when the real-time SoC of the battery is equal to or below the threshold SoC level, the method includes activating the generator to generate and supply the electrical power from the generator to the TRU based on a real-time electrical power consumption of the TRU.

In one or more embodiments, the electrical power generated by or available at the generator is determined based on a power-vs-speed characteristic of the generator, and where the power-vs-speed characteristic is determined based on any one or more of, the speed of rotation of the axle, one or more design parameters of the trailer and the generator, and one or more road attributes of a road on which the trailer is moving during the trip.

An aspect of the present disclosure relates to a power supply control system for a TRU equipped with a battery and a generator connected to an axle of TRU, the power supply control system including, at least processor, a controller configured to send an electronic control signal outside the power supply control system to the generator, and a memory storing instructions executable by the at least one processor, the instructions when executed cause the system to activate the generator, via the electronic control signal to generate and supply the electrical power to the battery and/or the TRU during a trip after the TRU consumes and depletes energy stored in the battery to or below a threshold state of charge (SoC) level.

The foregoing summary is illustrative only and is not intended to be in any way limiting. In addition to the illustrative aspects, embodiments, and features described above, further aspects, embodiments, features, and techniques of the subject disclosure will become more apparent from the following description taken in conjunction with the drawings.

### BRIEF DESCRIPTION OF THE DRAWINGS

The accompanying drawings are included to provide a further understanding of the subject disclosure and are incorporated in and constitute a part of this specification. The drawings illustrate exemplary embodiments of the subject disclosure and, together with the description, serve to explain the principles of the subject disclosure.

In the drawings, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIGS. 1A and 1B illustrate exemplary representations of the system for enabling power supply management in a transport refrigeration unit (TRU) equipped with an axle generator and a battery, in accordance with one or more embodiments of the subject disclosure.

FIG. 2 illustrates an exemplary block diagram depicting functional modules of the power supply control system for the TRU, in accordance with one or more embodiments of the subject disclosure.

FIG. 3 illustrates a flowchart of a method for enabling power supply management in a TRU equipped with an axle generator, and a battery, in accordance with one or more embodiments of the subject disclosure.

FIG. 4 illustrates an exemplary plot depicting variation in the battery SoC, the trailer's speed, the generator power, and the electrical power consumption of the TRU.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the subject disclosure as defined by the appended claims.

Various terms are used herein. To the extent a term used in a claim is not defined below, it should be given the broadest definition persons in the pertinent art have given that term as reflected in printed publications and issued patents at the time of filing.

In the specification, reference may be made to the spatial relationships between various components and to the spatial orientation of various aspects of components as the devices are depicted in the attached drawings. However, as will be recognized by those skilled in the art after a complete reading of the subject disclosure, the components described herein may be positioned in any desired orientation. Thus, the use of terms such as “above,” “below,” “upper,” “lower,” “first,” “second,” or other like terms to describe a spatial relationship between various components or to describe the spatial orientation of aspects of such components should be understood to describe a relative relationship between the components or a spatial orientation of aspects of such components.

Transport refrigeration units (TRUs), commonly known as reefer units, are essential for allowing for the safe and efficient temperature-controlled transport of perishable goods over long distances. These units may rely on a battery or external power source to power the TRU for cooling, heating, and ventilation, among other functions. An important aspect of these systems is ensuring a consistent and reliable power source, not only for the refrigeration process, but also for the auxiliary systems that support the unit's operation, including the battery system that powers electronic controls, safety systems, and other essential components.

Existing reefer units involve an axle generator for powering the TRU and the battery. The generator may be connected to an axle or a wheel hub associated with a trailer (or a vehicle or container) on which the TRU is installed. The generator may generate energy for supplying power to the TRU, and charging the battery upon movement of the trailer or rotation of the axle above a certain speed. However, this setup has been identified as inefficient in terms of energy use. Specifically, it has been observed that the trailer is driven using a combustion engine where (additional) fuel burning becomes particularly challenging. For instance, additional fuel may have to be burnt by the combustion engine (which may also be the prime mover of a container/trailer of the TRU) to overcome resistance from the generator during power generation. Additional fuel may be expended to increase torque and overcome the resistance of the generator. Further, the amount of energy generated depends on the speed of the vehicle, where increased speed corresponds to increased energy generation. However, speeding not only increases fuel consumption, but also leads to higher maintenance costs and increased emissions. The possibility of speeding is also dependent on roads in which a vehicle carrying the TRU is traveling.

Existing vehicles/TRUs are designed to actuate the axle generator when a state of charge (SoC) of the battery falls below 100%, thereby ensuring that the battery is maximally charged. In some solutions, the axle generators are also actuated when the TRU is actuated and starts consuming power. However, such logic leads to inefficiencies, and increases the fuel burn impact or fuel consumption of the trailer significantly (such as up to 13 to 14 liters of diesel per hour).

The subject disclosure overcomes the above-mentioned shortcomings and limitations associated with the existing generator-based reefer units/TRUs and associated power supply management, by providing an improved, cost-effective, and efficient solution that optimizes the electrical power usage in reefer units/TRU, ensuring that the generator and the battery are effectively and efficiently utilized without compromising the operation of the TRU.

In one or more embodiments, the transport refrigeration unit (TRU) may be installed on a container or trailer associated with a vehicle (also referred to as a trailer or prime mover, herein). The TRU may be configured to maintain a conditioned environment in an enclosed (storage or conservation) space within the container/trailer. Various products, including, but not limited to, pharmaceutical and nutraceutical products, and perishable items, such as foods and beverages, and the like, may be stored and transported in the container/trailer. The TRU may maintain the environment of the storage space at a specific or user-defined temperature and/or humidity, based on the stored products, to keep the stored products in a healthy condition while transporting and comply with product compliance regulations.

The TRU may be installed on the container/trailer associated with one or more trailers, including, but not limited to, an electric truck, a semi-electric truck, and a non-electric truck, such that the TRU remains fluidically connected to the ambient and further remains fluidically connected to the storage space of the container/trailer. Accordingly, based on the environment to be maintained in the storage space or based on the products to be transported, the TRU may be operated to adjust its cooling capacity and supply conditioned air within the storage space. In addition, an axle which is a central shaft of the trailer rotates to provide power to the wheels by transmitting power from the engine to the wheels, allowing the trailer to move. The axles may be found in both front and rear positions on the trailer, and the axles may be powered or non-powered, depending on the vehicle's configuration (or engine/prime mover thereof). The powered axles receive power from the engine, while the non-powered axles support the weight of the trailer and a load associated with the trailer.

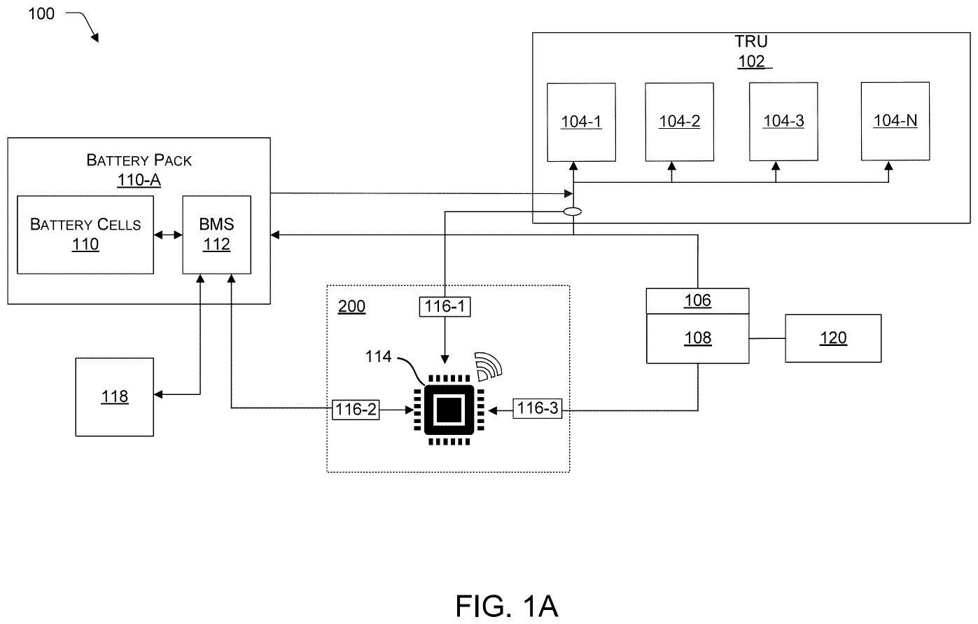

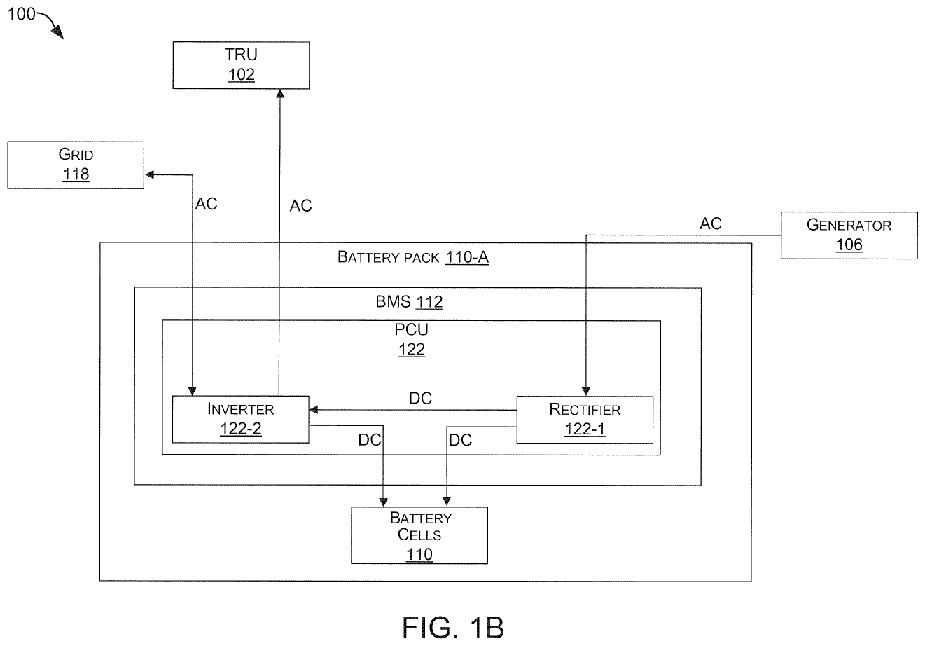

Referring to FIGS. 1A and 1B, a power supply system 100 (also referred to as a system 100, herein) for the TRU 102 is disclosed. The system 100 may include a generator 106 (also referred to as an axle generator or hub generator, herein) that may be operatively coupled to an axle or a wheel hub 108 associated with a trailer (not shown). Further, an engine 120 associated with the prime mover or vehicle may be configured to drive the trailer, which may cause the axle or wheel hub 108 of the trailer to rotate, thereby actuating the generator 106 to generate electrical power based on the rotational speed of the axle/hub 108 or speed of the trailer. In addition, the system 100 may include a battery 110 configured with a battery monitoring system (BMS) 112. In one or more embodiments, the system 100 may include an existing battery and BMS associated with the vehicle or TRU 102. However, in other embodiments, the battery 110 and BMS 112 may also be additionally installed on the TRU 102 or vehicle associated with the TRU 102.

The battery 110 may be electrically connected to the generator 106 via the BMS 112. In addition, the battery 110 may also be configured to be electrically connected to an external electrical power source 118, such as, but not limited to, an electrical grid. The BMS 112 may be configured to control the charging of the battery 110 via the generator 106 or the grid 118, and further enable the supply of electrical power from the battery 110 to one or more components 104-1 to 104-N (collectively designated as 104, herein) of the TRU 102 or the trailer. Further, the battery 110 and the generator 106 may be electrically coupled to the components 104 of the TRU 102. In one or more embodiments, the components 104-1 to 104-N of the TRU 102 may include, but are not limited to, a compressor, condenser fan, evaporator fan, and electric heater.

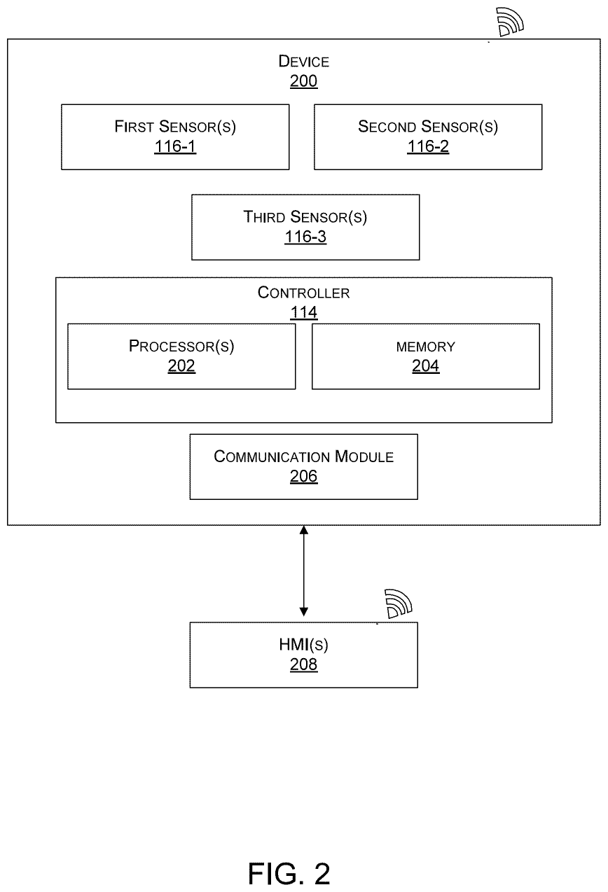

In one or more embodiments, the system 100 may include a power supply control system 200 (also referred to as a system 200, herein) configured to be connected to the generator 106, the battery 110, the BMS 112, and/or the components 104 of the TRU 102. The system 200 may be retrofitted in existing TRUs being equipped with an axle generator 106 and a battery 110. Referring to FIGS. 1A and 2, the system 200 may include a first set of sensors 116-1 electrically configured with the components 104 of the TRU 102 and the generator 106, to monitor the electrical power consumed by the components 104 or the TRU 102 in real-time, and also monitor the electrical power generated by the generator 106. Further, the system 200 may include a second set of sensors 116-2 operatively configured with the BMS 112 associated with the battery 110 to monitor the real-time state of charge (SoC) of the battery 110. Furthermore, the system 200 may include a third set of sensors 116-3 operatively configured with the axle 108 of the trailer to monitor the rotational speed of the axle 108 and the road attributes associated with the road during the trip. The rotational speed of the axle 108 and the road attributes associated with the road may allow the system 200 to determine electrical power generated by or available at the generator 106. The road attributes may include, but are not limited to, an inclination, a gradient, a downhill condition, and the like.

In one or more embodiments, the first and second set of sensors 116-1, 116-2 may include a current sensor, a voltage sensor, a watt meter, an energy meter, and a frequency and phase meter, but is not limited to the like. Further, the third set of sensors 116-3 may include an inclinometer (Tilt Sensor), accelerometer, gyroscope, GPS sensor, speed sensor (wheel or axle speed sensor), and gradient sensor, but is not limited to the like.

The system 100 or system 200 may further include a controller 114 in communication with the first, second and third set of sensors 116-1, 116-2, 116-3 and further operatively connected to the generator 106, the BMS 112, and the components 104 of the TRU 102. The controller 114 may include one or more processors 202 coupled to a memory 204 storing instructions executable by the processors 202, which causes the controller 114 to perform one or more designated operations.

The one or more processor(s) 202 may be implemented as one or more microprocessors, microcomputers, microcontrollers, digital signal processors, central processing units, graphical processing units, logic circuitries, and/or any devices that manipulate data based on operational instructions. Among other capabilities, the one or more processor(s) 202 may be configured to fetch and execute computer-readable instructions stored in a memory 204. The memory 204 may store the computer-readable instructions or routines, which may be fetched and executed to create or share the data units to other elements of the controller 114. The memory 204 may include any non-transitory storage device including, for example, volatile memory such as Random Access Memory (RAM), or non-volatile memory such as an Erasable Programmable Read-Only Memory (EPROM), flash memory, and the like.

In one or more embodiments, the controller 114 of the power supply control system 200 may be configured to send an electronic control signal to the generator 106 to activate the generator to generate and supply electrical power to the battery 110 and/or the TRU 102 during a trip after the TRU 102 depletes energy stored in the battery 110 to or below a threshold SoC level.

Unlike existing solutions where the generator 106 is activated as soon as a real-time or current SoC of the battery 110 falls below 100% (to ensure that the battery 110 is always maximally charged), the controller 114 may delay the activation of the generator 106 until the real-time/current SoC of the battery 110 is equal to or less than (or below) the threshold SoC level. In such embodiments, the controller 114 may reduce the amount of fuel burned by an engine of a tailer to drive the generator 106 during the trip (i.e., due to additional torque required to drive the generator to generate the electrical power), thereby making the overall system efficient and cost-effective, without compromising the operation of the TRU.

The power supply control system 200 (and the system 100) reduces operational latency between the controller 114 and the generator 106, thereby improving precision of control and performance of the system 200 (and of system 100). Furthermore, the communication of the control signal between the controller 114 and the generator 106 can be achieved through an encryption authorization protocol, such as Transport Layer Security (TLS), Internet Protocol Security (IPsec), Symmetric-Key Encryption, custom cryptographic protocols, Secure Boot/Trusted Platform Modules (TPMs), Hardware Security Modules (HSMs), and the like, but not limited thereto. This secure transmission allows for security of the system 200 by preventing unauthorized access by nature of the secure transmission between the controller 114 and the generator 106.

In one or more embodiments, the controller 114 may be configured to monitor the electrical power consumption of the TRU 102 over a duration for one or more trips (previous trips and/or an ongoing trip) using the first set of sensors 116-1. This may allow the controller 114 to determine the average electrical power consumption of the TRU 102 for the ongoing or upcoming trips. The controller 114 may accordingly predict the electrical power consumption of the TRU 102 for the trip (ongoing trip) of a corresponding duration, based on the determined average electrical power consumption of the TRU 102. The corresponding duration of the trip herein corresponds to the effective operational duration of the TRU 102 during the trip which includes the ON duration of the TRU 102, excluding the OFF duration during the trip. For instance, if the total trip duration is 4 hours, but the TRU 102 may be turned off for 30 minutes during that trip, the trip's effective duration is 3.5 hours. Consequently, the electrical power consumption of the TRU 102 is calculated based on 3.5 hours, not the full 4 hours.

Further, the controller 114 may monitor the real-time/current SoC of the battery 110 indicating amount of energy available in the battery 110, using the second set of sensors 116-2. The controller 114 may further monitor the rotational speed of the axle 108 or speed of the trailer during the ongoing trip using the third set of sensors 116-3 and correspondingly determine the electrical power that may be available at or generated by the generator 106. Accordingly, the controller 114 may actuate the generator 106 to generate and supply electrical power available at the generator 106 to the battery 110 and/or the TRU 102 during the ongoing trip based on one or more of the predicted electrical power consumptions of the TRU 102, the real-time SoC of the battery 110 or the amount of energy available in the battery 110, and the electrical power available at the generator 106 (which may also be the rotational speed of the axle 108 or speed of the trailer).

In one or more embodiments, the controller 114 may activate the generator 106 by operably engaging a drive shaft of the generator 106 with the axle 108 of the trailer using one or more actuators, which may cause the drive shaft to rotate along with the axle 108, resulting in the generation of the electrical power.

In one or more embodiments, the controller 114 may be configured to adjust the activation duration of the generator 106 during the trip to enable the generator 106 to generate and supply an electrical power to the battery 110 for maintaining the SoC of the battery 110 above a threshold SoC level, i.e., for maintaining an amount of energy available in the battery to be above an energy level, during the trip for the corresponding duration. The threshold SoC level or the energy level may be selected based on the predicted electrical power consumption of the TRU 102 during the trip and the power storage capacity (rating) of the battery 110.

In a non-limiting example, for a battery with a capacity of 4 kilowatt-hours (kWh), if the TRU 102 is predicted to consume 1 kilowatt (kW) per hour, the TRU 102 may operate for 4 hours (4 kWh/1 kW=4 hours) before the battery is depleted. Accordingly, for a 1-hour trip, the threshold SoC level of the battery 110 may be selected as 25% of the battery capacity. This may allow the battery 110 to power the TRU 102 for at least 1 hour without depending on the generator 106 or grid power. In another non-limiting example, if the consumption rate of the TRU 102 doubles to 2 kW per hour, the operational time of the TRU 102 is halved, resulting in only 2 hours of operation (4 kWh/2 kW=2 hours) before the battery 110 is depleted. In such a scenario, for a 1-hour trip, the threshold SoC level of the battery may be selected as 50% of the battery capacity, allowing the battery 110 to power the TRU 102 for at least 2 hours without depending on the generator 106.

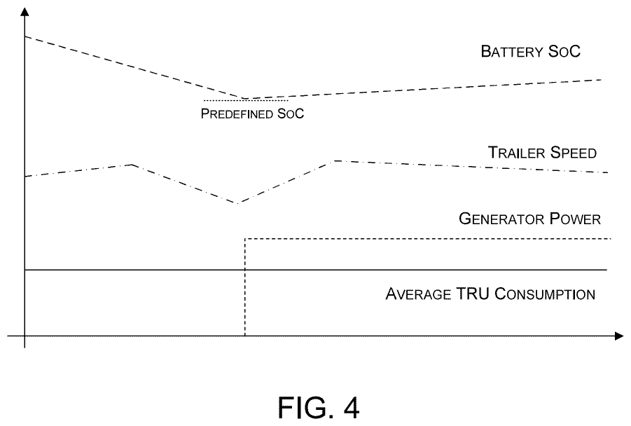

Referring to FIG. 4, an exemplary plot depicting variation in the battery SoC, the trailer's speed, the generator power, and the electrical power consumption of the TRU 102 during a trip is illustrated. As depicted, the generator 106 remains off and does not produce power if the real-time SoC of the battery 110 is above the SoC threshold. However, once the real-time SoC drops to the threshold SoC level or lower, the generator 106 is activated to generate and supply power to the battery 110, thereby maintaining the real-time SoC of the battery 110 above the SoC threshold. The power output of the generator 106 may correspond to (or be proportional to) the rotational speed of the axle 108 or the vehicle's speed (trailer).

In one or more embodiments, upon detecting the real-time SoC of battery 110 to be more than the threshold SoC level during the trip, the controller 114 may deactivate or disengage the generator 106 from the axle 108 to restrict the generator 106 from generating electrical power. Further, the controller 114 may actuate the BMS 112 to enable the supply of electrical power from the battery 110 to the components of the TRU 102 based on real-time electrical power consumption of the TRU 102. In a non-limiting example, if the threshold SoC level is determined and set at 25%, and the real-time SoC of the battery 110 remains above 25% while powering the TRU 102, the controller 114 may keep the generator 106 deactivated. This may help reduce the amount of fuel burned by the engine 120 of the trailer to drive the generator 106 during the trip (i.e., due to additional torque required to drive the generator 106 to generate the electrical power), thereby making the overall system efficient and cost-effective, without compromising the operation of the TRU 102.

Further, in one or more embodiments, upon detecting the real-time SoC of the battery 110 to be equal to or below the threshold SoC level, the controller 114 may be configured to activate the generator 106 to generate and supply the electrical power to the battery 110. In a non-limiting example, if the threshold SoC level is determined and set to be 25%, but the real-time SoC of the battery 110 reaches or goes below 25% while powering the TRU 102, the controller 114 may activate the generator 106 to supply electrical power to the battery 110.

In one or more embodiments, the generator 106 may also be directly electrically connected to the TRU 102. In such embodiments, upon detecting the real-time SoC of the battery 110 to equal to or below/less than the threshold SoC level, the controller 114 may be configured to activate (through transmission of control signals) the generator 106 to generate and supply the electrical power directly to the TRU 102 and/or the battery 110. This may allow the system to maintain the SoC of battery 110 above the threshold SoC level while powering the components of the TRU 102 based on the real-time electrical power consumption of the TRU 102.

Furthermore, in one or more embodiments, upon detecting the electrical power generated by or available at the generator 106 to be greater than the real-time electrical power consumption of the TRU 102, and the real-time SoC of the battery 110 is determined to be equal to or less than the threshold SoC level, the controller 114 may enable the generator 106 to supply electrical power from the generator 106 to the TRU 102 based on the real-time electrical power consumption of the TRU 102, and the real-time rotational speed of the axle 108 or speed of the trailer. In a non-limiting example, if the threshold SoC level of the battery 110 is set at 25%, and the real-time SoC of the battery 110 drops below this threshold while powering the TRU 102, but the power available from the generator 106 is detected to exceed the real-time power consumption of the TRU 102. In such a scenario, the controller 114 may activate the generator 106 to supply electrical power directly to the battery 110 while also powering the TRU 102. This arrangement may help maintain the battery's real-time SoC above the threshold SoC level, while ensuring that the power supply to the TRU 102 is not compromised.

Further, while supplying a portion of the generated electrical power to the battery 110 to charge the battery 110, the electrical power generated by or available at the generator 106 is determined based on generator power-vs-speed characteristics of the generator 106. The generator power-vs-speed characteristics are determined based on one or more of, the speed of rotation of the axle, one or more design parameters associated with the trailer and the generator 106, and the road attributes associated with the road on which the trailer is moving during the trip. For instance, in a non-limiting example, the generator may generate 0 to 3 KW of power when the trailer moves at 30 km/hr. Similarly, the generator may generate 0 to 15 KW of power when the trailer moves at 90 km/hr.

Furthermore, in one or more embodiments, the BMS 112 may further connect the battery 110 to the external power source 118 such as an electrical grid which may supply electrical power to the battery 110 when the trailer is stationary and the real-time SoC of the battery 110 is detected to be less than the threshold SoC level. Further, in one or more embodiments, the controller 114 may generate an alert signal to inform a driver or user about stopping the trailer and charging the battery 110, to keep the TRU operational.

In one or more embodiments, the system 100 or system 200 may include one or more human-machine interfaces (HMI) (208 as shown in FIG. 2) in communication with the controller 114. The controller 114 may allow one or more registered users to monitor one or more of, the real-time electrical power consumptions of the TRU 102, the electrical power generated by the generator 106, the SoC or electrical energy stored or available in the battery 110, and the electrical power supplied by the generator 106 to the battery 110. In one or more embodiments, the HMI 208 may be installed in a cabin of the trailer or vehicle and/or within the container/trailer on which the TRU 102 is installed. Further, in some embodiments, the HMI 208 may also be mobile phones or other portable computing device associated with the users, but not limited to the like.

In one or more embodiments, the system 200 may include a communication module 206 operatively coupled to the controller 114, which may enable the system 200 to establish a secured communication with the sensors, the BMS 112, the HMIs 208, and various other components 104 associated with the TRU 102 and vehicle. The communication module 206 may be wired media and/or wireless media. For instance, the communication module may include, but is not limited to, an antenna, an Ethernet port, a USB port, or any other port that may be configured to receive and transmit location and attributes data. Further, in one or more embodiments, the communication module 206 may include ethernet modules, wireless-fidelity (Wi-Fi) modules, Bluetooth modules, Zigbee modules, GSM/GPRS modules, LoRa modules, 5G modules, Recommended Standard (RS)-232/RS-485 serial communication modules, Controller Area Network (CAN) modules, but not limited to the like.

Referring to FIGS. 1A and 1B, in one or more embodiments, the battery 110 and the BMS 112 may be packaged or implemented as a battery pack 110-A. The battery pack 110-A may include one or more battery cell modules (also referred to as battery cells 110, herein), and a power conversion unit (PCU) 122 to convert electrical power received and/or supplied by the battery 110 in a predetermined range suitable for the battery cells 110, the TRU 102, and the grid (external power sources) 118. The battery pack 110-A may further include one or more interfaces to facilitate the connection of the battery 110 pack with the TRU 102, the generator 106, the controller 114, and the grid 118.

In one or more embodiments, the PCU 122 within the battery pack 110-A or BMS 112 may facilitate in managing and converting electrical power to ensure optimal performance, efficiency, and compatibility with connected loads (such as TRU 102) or charging sources (generator 106 or external power source 118). The PCU 122 may include one or more rectifiers 122-1, one or more inverters 122-2, and/or one or more direct current (DC)-DC converters (not shown). The rectifier(s) 122-1 may be configured to convert alternating current (AC) power supplied by the generator 106 or external power source 118 into DC power for the battery cells 110. Further, the inverters 122-2 may be configured to convert the DC power level output by the battery cells 110 into AC power for the AC power-based components 104 of the TRU 102 during a charging operation mode or power supply mode and/or to the grid 118 during a power export mode. Furthermore, the DC-DC converter may be configured to adjust the DC power level output by the battery cells 110 to match the input DC level for the DC power-based components 104 of the TRU 102 during the power supply mode. In addition, in one or more embodiments, the PCU 122 may include a bi-directional AC-DC converter (operating as the rectifier 122-1 as well as the inverter 122-2) configured to facilitate electrical power exchange between the battery cells 110 and the grid 118 (external power source). The PCU 122 may accordingly facilitate maximizing energy utilization and protection of the battery cells 110 from over-voltage or under-voltage conditions.

Another aspect of the present disclosure relates to a method for power supply management in a TRU equipped with a generator and a battery (such as TRU 102, generator 106, and battery 110 of FIGS. 1A and 1B). The method includes activating the generator to generate and supply electrical power to the battery and/or the TRU during a trip after the TRU depletes energy stored in the battery to or below a threshold SoC level. In one or more embodiments, the method may be executed by a controller (such as controller 114 of FIG. 1A).

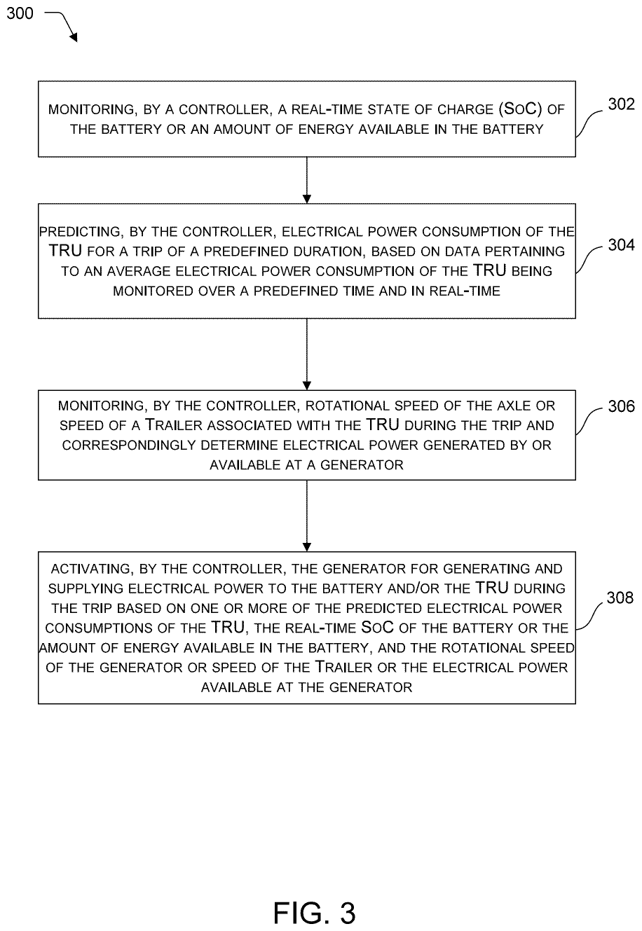

In one or more embodiments, the method may include further steps. Referring to FIG. 3, method 300 for enabling power supply management in a TRU (such as TRU 102 of FIGS. 1A to 2) is disclosed. Method 300 may involve a battery, a BMS, a generator, and a device (such as the battery 110, the BMS 112, the generator 106, the system 200, and other components associated with the system of FIGS. 1A and 1B). Method 300 may include step 302 of monitoring a real-time SoC of the battery, followed by step 304 of predicting the electrical power consumption of the TRU for a trip of a corresponding duration. The electrical power consumption of the TRU may be predicted based on data pertaining to an average electrical power consumption of the TRU for one or more trips (previous and/or ongoing trips) being monitored over a duration. The device or sensors (such as sensors 116-1 to 116-3 of FIG. 1A) may facilitate in monitoring the electrical power consumption of the TRU and the SoC maintained by the battery at steps 302, and 304. Further, method 300 may include step 306 of monitoring the rotational speed of the axle or speed of the trailer associated with the TRU during the ongoing trip and correspondingly determine electrical power generated by or available at a generator. Accordingly, method 300 may include step 308 of activating the generator for generating and supplying electrical power to the battery and/or the TRU during the trip based on any one or more of, the predicted electrical power consumptions of the TRU, the real-time SoC of the battery, the threshold SoC level, and the speed of the trailer or the electrical power available at the generator, after the TRU consumes, and thereby depletes, the real-time SoC to or below the threshold SoC level.

In one or more embodiments, method 300 may include the step of adjusting an activation duration of the generator during the trip to enable the generator to generate and supply an electrical power to the battery for maintaining the SoC of the battery above a (predefined) threshold SoC level during the trip. The threshold SoC level may be selected based on the predicted electrical power consumption of the TRU during the trip and the power storage capacity of the battery.

In one or more embodiments, when the real-time SoC of the battery is more than the threshold SoC level during the trip, method 300 may include the steps of deactivating or disengaging the generator from the axle to restrict the generator from generating electrical power. Further, method 300 may include the steps of actuating the BMS to enable the supply of the electrical power from the battery to the components of the TRU based on the real-time electrical power consumption of the TRU. This may help reduce the amount of fuel burned by the engine of the trailer to drive the generator during the trip, thereby making the overall system efficient and cost-effective, without compromising the operation of the TRU.

In one or more embodiments, when the real-time SoC of the battery reaches a first threshold SoC level, method 300 may include the steps of activating the generator for generating and supplying the electrical power to the battery until the real-time SoC of the battery reaches another/second threshold SoC level. The second threshold SoC level may be more than the first threshold SoC level. For instance, in a non-limiting example, once the SoC reaches a first threshold SoC level (say 30%), the generator may be kept activated to charge the battery until the SoC of the battery reaches second threshold SoC level (say 40%). This may help prevent frequent activation or deactivation of the generator.

Further, in one or more embodiments, when the real-time SoC of the battery is equal to or below the threshold SoC level, method 300 may include the steps of activating the generator to generate and supply the electrical power to the battery.

In one or more embodiments, the generator may also be directly electrically connected to the TRU. In such embodiments, when the real-time SoC of the battery is equal to or below the threshold SoC level, method 300 may include the steps activating the generator to generate and supply the electrical power directly to the TRU and/or the battery. This may allow the system to maintain the SoC of the battery above the threshold SoC level while powering the components of the TRU based on the real-time electrical power consumption of the TRU.

Furthermore, in one or more embodiments, when the electrical power generated by or available at the generator is greater than real-time electrical power consumption of the TRU and the real-time SoC of the battery is equal or below the threshold SoC level, method 300 may include the steps of enabling the generator to supply the electrical power from the generator to the TRU based on the real-time electrical power consumption of the TRU and the real-time rotational speed of the axle or speed of the trailer. This may help maintain the battery's SoC above the level and ensure that the power supply to the TRU is not compromised.

It may be appreciated that the steps of the method 300 may be performed in any order, and are not limited to the sequence/order described in the subject disclosure. Further, any two or more steps of the method 300 may be performed concurrently, without deviating from the score of the subject disclosure. For instance, the order of steps 302 to 306 of the method 300 may be performed in any order, or any two or more of the steps may be performed concurrently.

Thus, subject disclosure (system, device, and method) overcomes the shortcomings and limitations associated with the existing generator-based reefer units/TRUs and associated power supply management, by providing an improved, cost-effective, and efficient solution that optimizes the electrical power usage in reefer units/TRU, ensuring that the generator and the battery are effectively and efficiently utilized without compromising the operation of the TRU. Further, by allowing the electrical power/energy stored in the battery to be consumed by the TRU up to a threshold SoC level before actuating the generator minimizes the duration for which the generator is actuated, which in-turn minimizes the additional fuel consumed in order to drive the generator, thereby improving efficiency of the system.

While the subject disclosure has been described with reference to exemplary embodiments, it will be understood by those skilled in the art that various changes may be made and equivalents may be substituted for elements thereof without departing from the scope of the subject disclosure as defined by the appended claims. Modifications may be made to adopt a particular situation or material to the teachings of the subject disclosure without departing from the scope thereof. Therefore, it is intended that the subject disclosure not be limited to the particular embodiment disclosed, but that the subject disclosure includes all embodiments falling within the scope of the subject disclosure as defined by the appended claims.

In interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

1. A power supply system for a transport refrigeration unit (TRU), wherein the power supply system comprises:
a battery electrically connected to one or more components of the TRU;
a generator electrically connected to the battery, wherein the generator is operatively coupled to an axle of a trailer of the TRU, the generator being configured to generate electrical power upon rotation of the axle according to a rotational speed of the axle; and
a controller operatively coupled to the battery, the TRU, and the generator, wherein the controller is configured to:
activate the generator to generate and supply the electrical power to the battery and/or the TRU during a trip after the TRU depletes energy stored in the battery to or below a threshold state of charge (SoC) level.

2. The power supply system of claim 1, wherein the controller is further configured to:
monitor a real-time SoC of the battery, the real-time SoC indicating an amount of energy stored in the battery;
predict electrical power consumption of the TRU for the trip, based on data pertaining to an average electrical power consumption of the TRU being monitored over a preceding time interval and in real-time;
monitor the rotational speed of the axle during the trip and determine the electrical power generated by the generator based on the rotational speed; and
activate the generator to generate and/or supply the electrical power to the battery and/or TRU based on one or more of: the predicted electrical power consumption of the TRU, the real-time SoC of the battery, the threshold SoC level, and the electrical power generated by the generator.

3. The power supply system of claim 1, wherein the controller is further configured to adjust an activation duration of the generator during the trip based on a real-time SoC of the battery and the threshold SoC level.

4. The power supply system of claim 1, wherein the threshold SoC level is selected based on a predicted electrical power consumption of the TRU during the trip and a power storage capacity of the battery.

5. The power supply system of claim 1, wherein when a real-time SoC of the battery is more than the threshold SoC level, the controller is configured to deactivate the generator and enable the battery to supply the energy stored therein to the one or more components of the TRU based on a real-time electrical power consumption of the TRU.

6. The power supply system of claim 1, wherein when a real-time SoC of the battery is equal to or less than the threshold SoC level, the controller is configured to activate the generator to generate and supply the electrical power to the battery and the one or more components of the TRU concurrently, based on a real-time electrical power consumption of the TRU.

7. The power supply system of claim 1, when the real-time SoC of the battery is equal to or less than the threshold SoC level, the controller is configured to activate the generator to generate and supply the electrical power to the TRU based on a real-time electrical power consumption of the TRU, through an electrical connection between the generator and the one or more components.

8. The power supply system of claim 1, wherein the controller is configured to determine the electrical power generated by the generator based on a power-vs-speed characteristic of the generator, and wherein the power-vs-speed characteristic is determined based on any one or more of: the rotational speed of the axle, one or more design parameters of the trailer and the generator, and one or more road attributes of a road on which the trailer is moving during the trip.

9. The power supply system of claim 1, wherein the controller is further configured to determine and monitor the real-time SoC of the battery using a Battery Management System (BMS) associated with the battery.

10. The power supply system of claim 1, further comprising a power conversion unit to convert the electrical power generated by the generator into direct current (DC) power for the battery and/or into alternating current (AC) or DC power for the one or more components of the TRU.

11. A method for power supply management in a transport refrigeration unit (TRU) equipped with a generator and a battery, wherein the method comprises:
activating, by the controller, the generator operatively connected to the controller via an electrical control signal executable by at least one processor, to generate and supply electrical power to the battery and/or the TRU during a trip after the TRU depletes energy stored in the battery to or below a threshold state of charge (SoC) level.

12. The method of claim 11, further comprising:
predicting, by the controller, electrical power consumption of the TRU for the trip, based on data pertaining to an average electrical power consumption of the TRU being monitored over a preceding time interval and in real-time by a first set of sensors;
receiving, by the controller, a real-time SoC of the battery monitored by a second set of sensors, the real-time SoC indicating an amount of energy available in the battery;
receiving, by the controller, a rotational speed of an axle or speed of a trailer of the TRU during the trip from a third set of sensors and correspondingly determining electrical power generated by or available at a generator based on the rotational speed; and
after the TRU depletes the real-time SoC of the battery to or below the threshold SoC level, activating, by the controller, the generator via the electrical control signal for generating and supplying the electrical power to the battery and/or the TRU during the trip based on any one or more of: the predicted electrical power consumptions of the TRU, the real-time SoC of the battery, the threshold SoC level, and the electrical power available at the generator.

13. The method of claim 11, further comprising adjusting, by the controller, an activation duration of the generator during the trip based on a real-time SoC of the battery above the threshold SoC level during the trip via transmission of the electronic control signal.

14. The method of claim 11, wherein the threshold SoC level is selected based on the predicted electrical power consumption of the TRU during the trip and a power storage capacity of the battery.

15. The method of claim 11, further comprising transmitting, by the controller, another electronic control signal for deactivating the generator and enabling the battery to supply the energy stored therein to one or more components of the TRU based on a real-time electrical power consumption of the TRU, when the real-time SoC of the battery is more than the threshold SoC level.

16. The method of claim 11, wherein when a real-time SoC of the battery is equal to or less than the threshold SoC level, the method comprises activating, by the controller, the generator via the electronic control signal to generate and supply the electrical power to the battery until the real-time SoC of the battery reaches another threshold SoC level, wherein the another threshold SoC level is more than the threshold SoC level.

17. The method of claim 11, further comprising activating the generator via the electronic control signal, by the controller, for generating and supplying the electrical power to the battery and one or more components of the TRU based on a real-time electrical power consumption of the TRU, when a real-time SoC of the battery is equal to or below the threshold SoC level.

18. The method of claim 11, wherein when the real-time SoC of the battery is equal to or below the threshold SoC level, the method comprises activating, by the controller, the generator via the electronic control signal to generate and supply the electrical power from the generator to the TRU based on a real-time electrical power consumption of the TRU.

19. The method of claim 11, wherein the electrical power generated by or available at the generator is determined based on a power-vs-speed characteristic of the generator, and wherein the power-vs-speed characteristic is determined based on any one or more of: the speed of rotation of the axle, one or more design parameters of the trailer and the generator, and one or more road attributes of a road on which the trailer is moving during the trip.

20. A power supply control system for a transport refrigeration unit (TRU) equipped with a battery and a generator connected to an axle of TRU, the power supply control system for a TRU comprising:
at least one processor;
a controller configured to send an electronic control signal outside of the power supply control system to the generator; and
a memory storing instructions executable by the at least one processor, the instructions when executed cause the system to:
activate the generator, via an electronic control signal executable by the at least one processor, to generate and supply electrical power to the battery and/or the TRU during a trip after the TRU depletes energy stored in the battery to or below a threshold state of charge (SoC) level.
